(19) United States
(12) Patent Application Publication
(10) Pub. No.: US 2026/0034910 A1
(43) Pub. Date: Feb. 5, 2026

(54) VEHICLE HAVING AN ELECTRICAL ON-BOARD POWER SUPPLY

(71) Applicant: MERCEDES-BENZ GROUP AG, Stuttgart (DE)

(72) Inventors: Norbert CHLOUBA, Oberboihingen (DE); Urs BOEHME, Ehningen (DE); Stefan SEIFFERT, Filderstadt (DE)

(21) Appl. No.: 18/996,167

(22) PCT Filed: Jul. 13, 2023
(86) PCT No.: PCT/EP2023/069594

§ 371 Date: Jan. 17, 2025

(30) Foreign Application Priority Data
Jul. 18, 2022 (DE) 10 2022 002 622.8

(51) Int. Cl. B60L 53/62; B60L 53/20

(52) U.S. Cl. CPC B60L 53/62; B60L 53/20; B60L 2210/10; B60L 2240/547

(57) ABSTRACT

An electrical on-board power supply of a vehicle includes a traction battery, a charging connection for coupling to a DC charging station, a positive potential line, a negative potential line, reference potential line, and a voltage measuring device between the positive potential line and the reference potential line and/or between the negative potential line and the reference potential line. A DC converter is arranged in the positive potential line and/or in the negative potential line. An isolating element is arranged in the positive potential line and/or in the negative potential line. A processing unit is configured to evaluate the measured voltage(s) and to control opening of the respective isolating element. The processing unit is configured to cause the respective isolating element to open when the triggering criterion or one of the multiple or all of the triggering criteria is/are determined to occur.

### BACKGROUND AND SUMMARY OF THE INVENTION

Exemplary embodiments of the invention relate to a vehicle having an electrical on-board power supply.

A protective device for an electrical DC network, an on-board power supply for a vehicle, a vehicle and a DC charging station are known from the prior art, as described in DE 10 2019 008 833 A1. The protective device comprises a first voltage measuring device between a positive potential line and a reference potential line and a second voltage measuring device between a negative potential line and the reference potential line, or a fault current measuring device in the reference potential line. The protective device further comprises a protective circuit having two protective circuit parts, wherein the first protective circuit part comprises a series connection of a first discharge resistor and a first circuit breaker between the positive potential line and the reference potential line and the second protective circuit part comprises a series connection of a second discharge resistor and a second circuit breaker between the negative potential line and the reference potential line. The first and second circuit breakers can be triggered to close when the voltage falls below and/or exceeds a predetermined value as determined by the first and/or second voltage measuring device, or the first and/or second circuit breaker can be triggered to close when a fault current is measured by the fault current measuring device.

A protective device for an electrical DC network, an on-board power supply for a vehicle, a vehicle, and a DC charging station are described in DE 10 2021 003 830. The protective device comprises a first voltage measuring device between a positive potential line and a reference potential line for measuring a voltage between the positive potential line and the reference potential line, and a second voltage measuring device between a negative potential line and the reference potential line for measuring a voltage between the negative potential line and the reference potential line. The protective device further comprises a protective circuit for reducing an electric shock caused by Y capacitors of the electrical DC network, wherein the protective circuit comprises a first circuit breaker between the positive potential line and the reference potential line and a second circuit breaker between the negative potential line and the reference potential line. Several triggering criteria are predetermined. The first circuit breaker and/or the second circuit breaker can only be triggered to close when all predetermined triggering criteria are met as determined by the first voltage measuring device and/or by the second voltage measuring device.

An energy coupler for electrically coupling electrical on-board power supplies and a method for electrically coupling electrical on-board power supplies are known from DE 10 2017 009 352 A1. The energy coupler for electrically coupling a first electrical on-board power supply to which a first electrical DC voltage is applied to a second electrical on-board power supply to which a second electrical DC voltage is applied has a first and a second clocked energy converter, each of which has an on-board power supply connection and an intermediate circuit connection. The on-board power supply connection of the first clocked energy converter is connected to the first on-board power supply and the on-board power supply connection of the second clocked energy converter is connected to the second on-board power supply. The intermediate circuit connections of the first and second clocked energy converter are connected to a common DC intermediate circuit. A first electrical potential of the DC intermediate circuit is electrically connected to one of the electrical potentials of the first on-board power supply by means of the first clocked energy converter. A second electrical potential of the intermediate of the DC intermediate circuit is electrically connected to one of the electrical potentials of the second on-board power supply by means of the second clocked energy converter.

Exemplary embodiments of the invention are directed to a vehicle having an electrical on-board power supply which is improved in relation to the prior art.

A vehicle has an electrical on-board power supply. The electrical on-board power supply comprises a traction battery, i.e., an electrochemical energy storage device for supplying electrical energy to at least one electric drive motor for driving the vehicle, a charging connection for electrical coupling to a vehicle-external DC charging station, in particular for charging the traction battery, a positive potential line electrically coupled or couplable to the traction battery, a negative potential line electrically coupled or couplable to the traction battery and a reference potential line, in particular a ground potential line. Furthermore, the electrical on-board power supply comprises a voltage measuring device between the positive potential line and the reference potential line for measuring a voltage between the positive potential line and the reference potential line and/or a voltage measuring device between the negative potential line and the reference potential line for measuring a voltage between the negative potential line and the reference potential line.

In accordance with the invention, a galvanically coupled DC voltage converter is arranged in the positive potential line and/or a galvanically coupled DC voltage converter is arranged in the negative potential line. Furthermore, in accordance with the invention, an isolating element is arranged in the positive potential line and/or an isolating element is arranged in the negative potential line. In addition, in accordance with the invention, a processing unit coupled to the voltage measuring device or voltage measuring devices and to the isolating element or isolating elements is provided, which is designed and set up to evaluate the measured voltage or measured voltages and to open the isolating element or isolating elements. According to the invention, a triggering criterion is predetermined or multiple triggering criteria are predetermined which is/are based on the measured voltage or on the measured voltages. In accordance with the invention, the processing unit is designed and set up to trigger the isolating element or the isolating elements to open, in particular exclusively, when the predetermined triggering criterion is determined to occur or, in particular exclusively, when one of the several predetermined triggering criteria is determined to occur or, in particular exclusively, when all the predetermined triggering criteria are determined to occur.

The solution according to the invention makes it possible, in a state coupled to the DC charging station, in particular for charging the traction battery, to recognize an insulation fault occurring in the vehicle while it is still occurring and to react to it in good time in order to prevent a short circuit in the traction battery. In such a case of an insulation fault in the vehicle, a further insulation fault in the opposite electrical potential on the DC charging station side can occur as a direct consequence. This causes a short circuit in the traction battery, which in the so-called CHAdeMO charging standard leads to the destruction of a ground potential line in a charging cable with which the vehicle is electrically coupled to the DC charging station, as this ground potential line is only very thin.

The electrical on-board power supply is, in particular, a high-voltage on-board power supply. A positive potential and a negative potential of the on-board power supply are thus high-voltage potentials, also referred to as HV potentials below, i.e., the term high-voltage is abbreviated to HV below.

Before the short circuit of the traction battery occurs, the first step is always a voltage overload of the insulation in the DC charging station. One cause of this insulation overload can be that the HV potential distribution changes slowly in the event of a gradually developing insulation fault in the vehicle, i.e., with a slowly decreasing insulation resistance. Another cause of this overloading of the insulation can be that the HV potential distribution changes very quickly in the event of an immediate low-resistance insulation fault in the vehicle, i.e., if the insulation resistance is suddenly reduced to a very low value. Another cause of this overloading of the insulation can be a HV potential shift due to a recharging process by an insulation monitor. The HV potential distribution changes with a time constant that results from the total capacitance of the HV system, the insulation resistances and a resistance and thus a displacement current of the insulation monitor.

The aim of the solution according to the invention is therefore, in particular, to recognize an imminent overload of the insulation in the DC charging station based on the voltage measurement of the HV potentials to the reference potential and to isolate the HV systems vehicle and DC charging station before the overload occurs. This enables current-free isolation. The isolating element used for this or the respective isolating element used for this can therefore be designed to be correspondingly small, i.e., it is designed for a useful current, in particular for charging the traction battery by means of the DC charging station, and does not have to be designed for the short-circuit current.

If the overload of the insulation occurs suddenly, the reaction must also be very fast by opening the isolating element or the respective isolating element. Here too, an evaluation of the voltage of the HV potentials in relation to the reference potential can be used. In particular, a component that is as fast as possible is used as the isolating element. The isolating element or respective isolating element is designed, for example, as a semiconductor switch, in particular as a metal oxide semiconductor field effect transistor (MOSFET), or as a pyrotechnical isolating element, i.e., as a fuse with a snap element, also known as a pyro fuse. The evaluation of the voltage measurements and the conclusion on the fault resistance, more precisely on the time constant t=R*C of the capacitor discharge, wherein R is the body resistance of the human body, can be designed as described in DE 10 2021 003 830, in particular as described on pages 2 to 11 thereof, in particular on pages 5 to 7 thereof, in particular as described in the description of the figures and the figures, in particular on pages 27 to 29 thereof, in particular as described in the claims, in particular in claims 2 to 4 thereof. The resulting advantage is that even in the event of a sudden insulation fault, the traction battery circuit can be isolated even though there is still no voltage overload on the insulation of the DC charging station and thus even before the short-circuit current builds up.

By measuring the voltage of the HV potentials to the reference potential using the solution according to the invention, the occurrence of a critical insulation fault can be recognized and reacted to. A critical insulation fault occurs when the voltage between an HV potential and the reference potential at the charging connection rises above a defined threshold value of, for example, 500V. In the event of an insulation fault, the voltage increase from an HV potential to the reference potential is always associated with a reduction in the voltage of the other HV potential to the reference potential. By a logical AND-operation of these two events, EMC interference (common mode) can be partially suppressed (EMC=electromagnetic compatibility). The time constant of the recharging of the HV potentials can be used to determine the resistance of the insulation fault. This means that a developing insulation fault can be recognized even though the load limit of the insulation in the DC charging station has not yet been reached. Using the evaluation method as described in DE 10 2021 003 830, in particular in the above-mentioned passages, the insulation fault can be reliably distinguished from EMC interference or the influence of the insulation monitor. In a voltage measurement according to the solution according to the invention with two DC converters and two voltage measuring devices, wherein the voltage measuring devices are connected between the respective DC converter and the traction battery with the respective potential line, the potential shifts of the two DC converters can be calculated back in order to draw conclusions about the HV potential distribution at the charging connection. Alternatively, the HV voltage distribution is measured at the charging connection. For this purpose, the voltage measuring devices are connected to the respective potential line at the charging connection.

In the solution described here, it can thus be provided, for example, that the voltages measured by the voltage measuring devices are in particular analyzed as follows:
determining deviations of currently applied voltages dU from positive potential line to reference potential line and from negative potential line to reference potential line in relation to a previously determined voltage value, and/or determining voltage changes dU/dt, i.e., over time, of the voltages from positive potential line to reference potential line and from negative potential line to reference potential line, and/or
observing the opposite sign, in particular in the above two determinations, with regard to the evaluation of the voltages from positive potential line to reference potential line and from negative potential line to reference potential line, and/or
observing a cyclical repetition of an occurring fault.

In the solution described here, it can therefore be provided, for example, that the triggering criterion specified for the opening activation of the isolating element or isolating elements is one of the following or that the specified triggering criteria comprise one or more of the following:
a voltage deviation of a voltage currently present between the positive potential line and the reference potential line and a voltage present between the negative potential line and the reference potential line from a previously determined voltage value,
voltage changes in the voltage applied between the positive potential line and the reference potential line and the voltage applied between the negative potential line and the reference potential line,
an opposite sign of the voltage applied between the positive potential line and the reference potential line and the voltage applied between the negative potential line and the reference potential line, and/or
a non-existence of a cyclical repetition of the other triggering criteria.

By way of example, it is provided that the processing unit is designed and set up to trigger the isolating element or the isolating elements to open only if
the voltage deviation of the voltage currently present between the positive potential line and the reference potential line and the voltage present between the negative potential line and the reference potential line from the previously determined voltage value exceeds a predetermined limit value, and
the voltage changes of the voltage applied between the positive potential line and the reference potential line and the voltage applied between the negative potential line and the reference potential line exceed a predetermined limit value, and
the opposite sign of the voltage applied between the positive potential line and the reference potential and the voltage applied between the negative potential line and the reference potential line is present.

By way of example, it is provided that the processing unit is designed and set up to trigger the isolating element or the isolating elements to open only if the absence of a cyclical repetition of the other triggering criteria is also determined.

The solution according to the invention thus makes it possible to design the isolating elements for a significantly lower current by recognizing an insulation fault that occurs by measuring the HV potential distribution. This means that expensive isolating elements, such as breakers, fuses, pyro fuses, large contactors, or several MOSFETs in parallel as semiconductor fuses, can be avoided. The respective isolating element is designed, for example, as a semiconductor switch, in particular as a metal oxide semiconductor field effect transistor (MOSFET), wherein the isolating element, as already mentioned, only has to be designed for the charging current and not for the short-circuit current.

The advantage of using a metal oxide semiconductor field effect transistor (MOSFET) as an isolating element is that it also enables bidirectionality, which not only allows the traction battery to be charged via the charging connection, but also, conversely, allows a unit connected to the charging connection to be supplied with electrical energy by the traction battery. This is also known as buck operation and is used, for example, to feed electrical energy back into a public power grid or a building's power grid, in particular via the DC charging station, or to supply electrical energy to an electrical device.

The solution according to the invention also allows galvanically coupled DC converters to be used, wherein the DC converters in particular enable the traction battery to be charged at a DC charging station with a charging voltage that is lower than the battery voltage of the traction battery, for example charging an 800V traction battery at a DC charging station with a charging voltage of 400V or 500V, wherein damage and danger to persons are avoided in the event of a fault, in particular in the event of the insulation fault described above. This means that no other, significantly more cost-intensive solutions are required which also enable this charging of the traction battery, for example the use of a switchover battery as a traction battery, the use of a galvanically separated DC converter or the use of a quasi-insulated DC converter.

The processing unit is designed and set up, for example, for analog and/or digital evaluation of the measured voltage or voltages. By way of example, the analogue and digital evaluation are implemented simultaneously, in particular as redundancy.

The respective isolating element can, for example, be arranged between the charging connection and the respective DC converter or between the respective DC converter and the traction battery.

An electrical connection between the voltage measuring device or the respective voltage measuring device and the potential line can be arranged, for example, at the charging connection, between the charging connection and the respective DC converter, between the respective DC converter and the traction battery or between the charging connection and the traction battery.

If only one DC converter and only one isolating element are provided, it is in particular provided that the DC converter is arranged in the positive potential line and the isolating element in the negative potential line or that the DC converter is arranged in the negative potential line and the isolating element in the positive potential line.

Exemplary embodiments of the invention are explained in more detail below with reference to the drawings.

### BRIEF DESCRIPTION OF THE DRAWING FIGURES

Here are shown:

FIG. 1 schematically, an embodiment of an electrical on-board power supply of a vehicle electrically connected to a DC charging station,

FIG. 2 schematically, a further embodiment of an electrical on-board power supply of a vehicle electrically connected to a DC charging station, and

FIG. 3 schematically, an embodiment of an electrical on-board power supply of a vehicle electrically connected to a DC charging station.

Parts corresponding to one another are provided with the same reference numerals in all figures.

### DETAILED DESCRIPTION

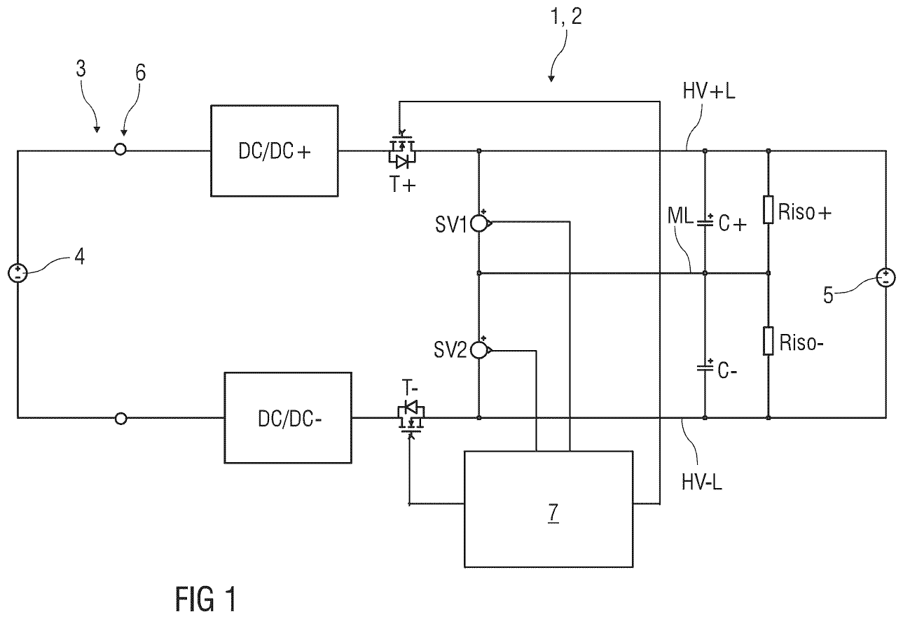

FIGS. 1 to 3 show various embodiments of an electrical on-board power supply 1 of a vehicle 2, which is connected to a DC charging station 4 via a charging cable 3 in the example depicted in each case. The electrical on-board power supply 1 is designed in particular as a high-voltage on-board power supply. The term “high-voltage”, also abbreviated to HV below, is to be understood in particular as an electrical DC voltage that is greater than approximately 60V. In particular, the term “high-voltage” is to be interpreted in accordance with the ECE R 100 standard.

The vehicle 2 is, in particular, an electric vehicle or a hybrid vehicle, i.e., it has at least one electric drive motor to drive it. The electrical on-board power supply 1 has a traction battery 5 to supply electrical energy to this at least one electric drive motor.

The electrical on-board power supply 1 also has a charging connection 6 for electrical coupling with the vehicle-external DC charging station 4. This occurs via the charging cable 3, which is electrically coupled to the DC charging station 4 and the charging connection 6 for this purpose.

The electrical on-board power supply 1 also has a positive potential line HV+L, a negative potential line HV−L, and a reference potential line ML. Furthermore, an insulation resistance Riso+ between the positive potential line HV+L and the reference potential line ML, an insulation resistance Riso− between the negative potential line HV−L and the reference potential line ML, a Y capacitor C+ between the positive potential line HV+L and the reference potential line ML, and a Y capacitor C− between the negative potential line HV−L and the reference potential line ML are in particular provided.

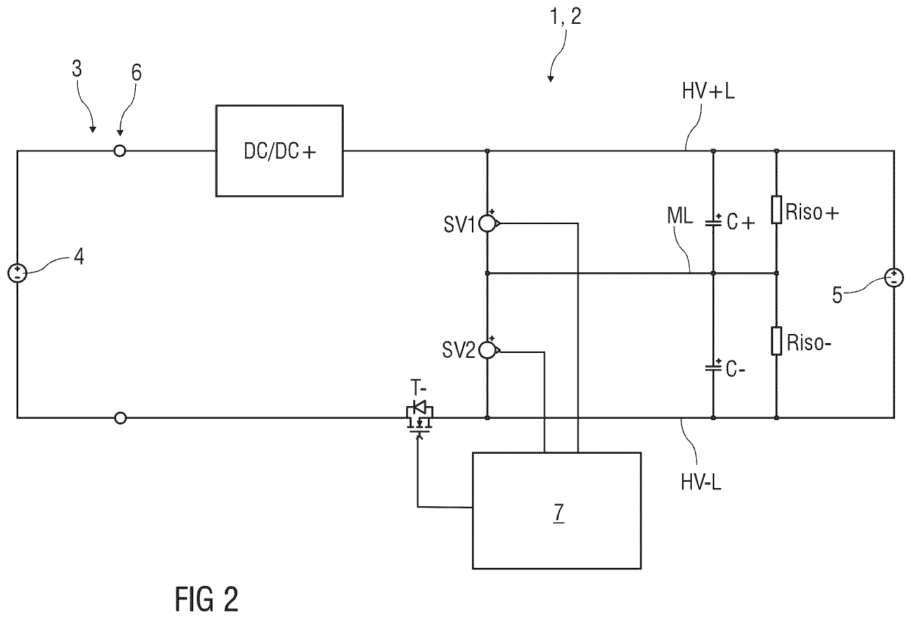

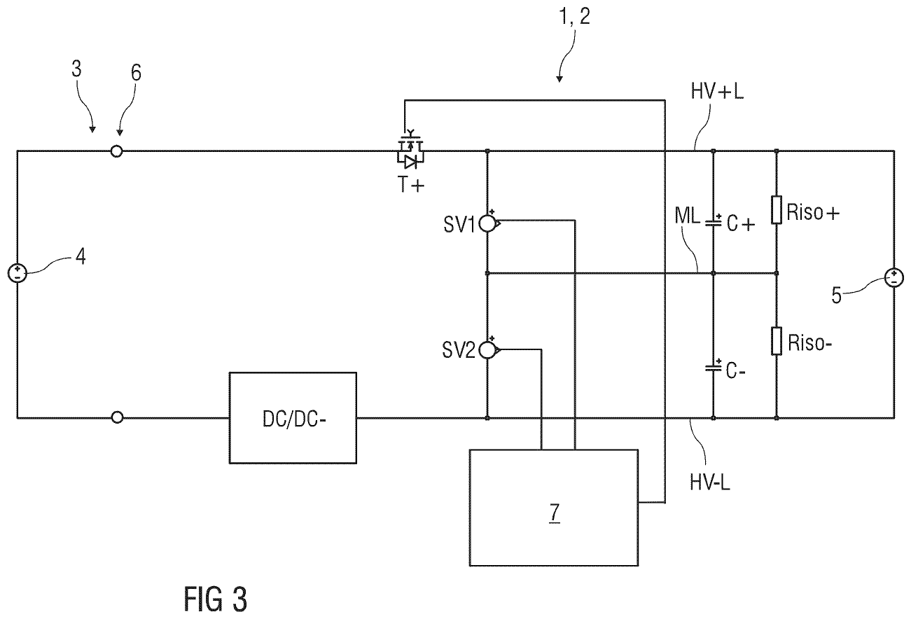

In the embodiment according to FIG. 1, a galvanically coupled DC converter DC/DC+, DC/DC− is arranged both in the positive potential line HV+L and in the negative potential line HV−L. In the embodiment according to FIG. 2, a galvanically coupled DC converter DC/DC+ is only arranged in the positive potential line HV+L. In the embodiment according to FIG. 3, a galvanically coupled DC converter DC/DC− is only arranged in the negative potential line HV−L.

In particular, the DC converter DC/DC+, DC/DC− or the two DC converters DC/DC+, DC/DC− enables/enable charging of the traction battery 5 with a charging voltage of the DC charging station 4 that is lower than a battery voltage of the traction battery 5, for example charging an 800V traction battery with a charging voltage of 400V or 500V. In particular, the design of the respective DC converter DC/DC+, DC/DC− as a coupled DC converter DC/DC+, DC/DC− also enables the traction battery 5 to supply electrical power to a unit connected to the charging connection 6, in particular by means of the charging cable 3. This is also referred to as buck operation and is used, for example, to feed electrical energy back into public power grid or a building's power grid, in particular via the DC charging station 4, or to supply electrical energy to an electrical device.

The problem with the described coupling of the on-board power supply 1 with the DC charging station 4 via the charging cable 3 is that if an insulation fault occurs in the vehicle 2, in particular between one of the potential lines HV+L, HV−L and a chassis of the vehicle 2, a further insulation fault can occur as a direct consequence in the opposite electrical potential on the part of the DC charging station 4, in particular to a metal housing of the DC charging station 4, as the high battery voltage of 800V, for example, is then applied to the DC charging station 4, which is designed for a lower charging voltage, whereby the insulation in the DC charging station 4 is overloaded. This causes a short circuit in the traction battery 5, which in the so-called CHAdeMO charging standard leads to a destruction of a ground potential line in the charging cable 6, as this ground potential line is only very thin.

Therefore, a solution is described below with reference to the embodiments according to FIGS. 1 to 3, which makes it possible to recognize the insulation fault occurring in the vehicle 2 while it is still developing and to react to it in good time in order to prevent the traction battery 5 from short-circuiting. For this purpose, a voltage measuring device SV1 between the positive potential line HV+L and the reference potential line ML for measuring a voltage between the positive potential line HV+L and the reference potential line ML and a voltage measuring device SV2 between the negative potential line HV−L and the reference potential line ML for measuring a voltage between the negative potential line HV−L and the reference potential line ML are provided.

Furthermore, in the embodiment according to FIG. 1, an isolating element T+ is arranged in the positive potential line HV+L and an isolating element T− is arranged in the negative potential line HV−L. In the embodiment according to FIG. 2, in which a DC converter DC/DC+ is only arranged in the positive potential line HV+L, an isolating element T− is only arranged in the negative potential line HV−L. In the embodiment according to FIG. 3, in which a DC converter DC/DC− is only arranged in the negative potential line HV−L, an isolating element T+ is only arranged in the positive potential line HV+L.

Instead of the two voltage measurements by means of the two voltage measuring devices SV1, SV2, for example, only one voltage measurement of one of the potentials to the reference potential can be provided. The one voltage measuring device SV1, SV2 is thus arranged between one of the potential lines HV+L, HV−L and the reference potential ML. A disadvantage here, however, is the susceptibility to interference of an evaluation and control of the one isolating element T+, T− or the two isolating elements T+, T− described below.

For this evaluation and control, a processing unit 7 coupled to the one voltage measuring device SV1, SV2 or to the two voltage measuring devices SV1, SV2 and to the one isolating element T+, T− or to the two isolating elements T+, T− is provided, which is designed and set up for evaluating the measured voltage or voltages and for opening control of the isolating element T+, T− or the isolating elements T+, T−. A triggering criterion or multiple triggering criteria based on the measured voltage or voltages is/are predetermined. The processing unit 7 is designed and set up to cause the one isolating element T+, T− or the two isolating elements T+, T− to open when the predetermined triggering criterion or one of the multiple predetermined triggering criteria or all predetermined triggering criteria is/are detected, whereby the traction battery 5 is isolated from the DC charging station 4.

The described solution is based on the principle that before the short circuit in the traction battery 5 occurs, a voltage overload of the insulation in the DC charging station 4 always occurs in a first step. The causes of this overload are described below. In the event of a gradually developing insulation fault in the vehicle 2, the HV potential distribution changes slowly. In the event of an immediate low-resistance insulation fault in the vehicle 2, the HV potential distribution changes very quickly. In the event of a potential shift due to a recharging process by an insulation monitor, the HV potential distribution changes with the time constant resulting from the total capacitance of the HV system, the insulation resistances Riso+, Riso− and the resistance due to the displacement current of the insulation monitor.

The aim of the solution described is therefore to recognize an imminent overload of the insulation in the DC charging station 4 based on the voltage measurement of the HV potentials to the reference potential and to isolate the HV systems of the vehicle 2 and the DC charging station 4, i.e., to open the one isolating element T+, T− or the two isolating elements T+, T− before the overload occurs. This allows current-free isolation and the isolating element T+, T− or the two isolating elements T+, T− can be designed to be small, as only a design for a useful current is required and no design for the short-circuit current is necessary. The one isolating element T+, T− or the two isolating elements T+, T− can thus be designed as a semiconductor switch, for example as a metal oxide semiconductor field effect transistor (MOSFET), as depicted here, or as a pyrotechnic isolating element.

If the overload occurs suddenly, the reaction by opening the isolating element T+, T− or the two isolating elements T+, T− must also occur very quickly. Here too, an evaluation of the voltage of the HV potentials in relation to the reference potential can be used. However, the isolating elements T+, T− must be components that are as fast as possible. The designs described above are suitable for this purpose. The evaluation of the voltage measurements and the conclusion on the fault resistance, more precisely on the time constant t=R*C, can be designed as described in DE 10 2021 003 830. The advantage of this is that even in the event of a sudden insulation fault, the circuit of the traction battery 5 can be isolated even though there is no voltage overload on the insulation of the DC charging station 4 and therefore even before the short-circuit current builds up.

By measuring the voltage of the HV potentials to the reference potential and evaluating them, it is possible to react to the following events and thus to the following triggering criteria:
A critical insulation fault occurs if the voltage between an HV potential and the reference potential at the charging connection 6 rises above a defined threshold value of 500V, for example.
In the event of an insulation fault, the voltage increase from one HV potential to the reference potential is always associated with a reduction in the voltage of the second HV potential to the reference potential. EMC interference (common mode) can be partially suppressed by a logical AND operation of these two events.
The resistance of the insulation fault can be deduced from the time constant of the recharging of the HV potentials. This means that a developing insulation fault can be recognized even though the load limit of the insulation in the DC charging station 4 has not yet been reached. Using the evaluation method, as described in DE 10 2021 003 830, the insulation fault can be reliably distinguished from EMC faults or the influence of the insulation monitor.
In a voltage measurement depicted in FIGS. 1 to 3, the potential shifts of the DC converters DC/DC+, DC/DC− can be calculated back in order to draw conclusions about the HV potential distribution at the charging connection 6. Alternatively, the voltage measurement and thus the measurement of the HV voltage distribution can be carried out at the charging connection 6.

With regard to the embodiments depicted, it should also be noted that the respective isolating element T+, T− is arranged here between the DC converter DC/DC+, DC/DC− and the traction battery 5 or between the charging connection 6 and the traction battery 5. In other embodiments, the respective isolating element T+, T− can also be arranged, for example, between the charging connection 6 and the respective DC converter DC/DC+, DC/DC−. Furthermore, in the embodiments depicted, an electrical connection of the voltage measuring device SV1, SV2 or the respective voltage measuring device SV1, SV2 to the potential line HV+L, HV−L is arranged between the respective DC voltage converter DC/DC+, DC/DC− and the traction battery 5 or between the charging connection 6 and the traction battery 5. In other embodiments, it can also be arranged at the charging connection 6 or between the charging connection 6 and the respective DC converter DC/DC+, DC/DC−.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

Reference numeral list

| | |
|---|---|
| 1 | on-board power supply |
| 2 | vehicle |
| 3 | charging cable |
| 4 | DC charging station |
| 5 | traction battery |
| 6 | charging connection |
| 7 | processing unit |
| C+, C− | Y capacitor |
| DC/DC+, DC/DC− | DC converter |
| HV + L | positive potential line |
| HV − L | negative potential line |
| ML | reference potential line |
| Riso+, Riso− | insulation resistance |
| SV1, SV2 | voltage measurement device |
| T+, T− | isolating element |

1-10. (canceled)

11. A vehicle comprising:
an electrical on-board power supply comprising
a traction battery;
a charging connection configured to electrically couple to a vehicle-external DC charging station;
a positive potential line;
a negative potential line;
a reference potential line;
a voltage measuring device, wherein the voltage measuring device is arranged between the positive potential line and the reference potential line to measure a voltage between the positive potential line and the reference potential line or the voltage measuring device is arranged between the negative potential line and the reference potential line to measure a voltage between the negative potential line and the reference potential line;
a galvanically coupled DC converter arranged in the positive potential line or arranged in the negative potential line;
an isolating element arranged in the positive potential line or arranged in the negative potential line; and
a processing unit, wherein the processing unit is coupled to the voltage measuring device, is coupled to the voltage measuring devices and to the isolating element, or is coupled to the isolating elements, wherein the processing unit is configured to evaluate the measured voltage and to control opening of the isolating element,
wherein a triggering criterion is predetermined based on the measured voltage,
wherein the processing unit is configured to cause the isolating element to open when the predetermined triggering criterion or one of the multiple predetermined triggering criteria or all of the predetermined triggering criteria is/are determined to occur,
wherein the predetermined triggering criterion is
a voltage deviation of a voltage currently present between the positive potential line and the reference potential line and a voltage present between the negative potential line and the reference potential line from a previously determined voltage value,
voltage changes in the voltage present between the positive potential line and the reference potential line and the voltage present between the negative potential line and the reference potential line,
an opposite sign of the voltage present between the positive potential line and the reference potential line and the voltage present between the negative potential line and the reference potential line, or
a non-existence of a cyclical repetition of other triggering criteria.

12. The vehicle of claim 11, wherein the processing unit is configured to cause the isolating element to open only if
the voltage deviation of the voltage currently present between the positive potential line and the reference potential line and the voltage present between the negative potential line and the reference potential line from the previously determined voltage value exceeds a predetermined limit value, and
the voltage changes of the voltage applied between the positive potential line and the reference potential line and the voltage applied between the negative potential line and the reference potential line exceed a predetermined limit value, and
the opposite sign of the voltage applied between the positive potential line and the reference potential line and the voltage applied between the negative potential line and the reference potential line is present.

13. The vehicle of claim 12, wherein the processing unit is configured to cause the isolating element to open only if the non-existence of a cyclical repetition of the other triggering criteria is also determined.

14. The vehicle of claim 11, wherein the processing unit is configured to performed an analog or digital evaluation of the measured voltage or the measured voltages.

15. The vehicle of claim 11, wherein the isolating element is a semiconductor switch or as a pyrotechnic isolating element.

16. The vehicle of claim 15, wherein the semiconductor switch is a metal oxide semiconductor field effect transistor.

17. The vehicle of claim 11, wherein the isolating element is arranged between the charging connection and the galvanically coupled DC converter or between the galvanically coupled DC converter and the traction battery.

18. The vehicle of claim 11, wherein an electrical connection between the voltage measuring device and the potential line is arranged at the charging connection, between the charging connection and the galvanically coupled DC converter, between the respective galvanically coupled DC converter and the traction battery, or between the charging connection and the traction battery.

19. The vehicle of claim 11, wherein the galvanically coupled DC converter is an only DC converter of the electrical on-board power supply and the isolating element is an only isolating element of the electrical on-board power supply, wherein the galvanically coupled DC converter is arranged in the positive potential line and the isolating element is arranged in the negative potential or vice versa.
